(19) United States
(12) Patent Application Publication
(10) Pub. No.: US 2014/0257602 A1
(43) Pub. Date: Sep. 11, 2014

(54) METHODS AND SYSTEMS FOR INSTRUCTING AN AIRCRAFT TO PERFORM A GO-AROUND MANEUVER

(71) Applicant: Gulfstream Aerospace Corporation, Savannah, GA (US)

(72) Inventor: Randy Gaston, Savannah, GA (US)

(73) Assignee: Gulfstream Aerospace Corporation, Savannah, GA (US)

(21) Appl. No.: 14/190,327

(22) Filed: Feb. 26, 2014

Related U.S. Application Data
(60) Provisional application No. 61/773,642, filed on Mar. 6, 2013.

(51) Int. Cl. G08G 5/02

(52) U.S. Cl. CPC G08G 5/02
USPC 701/16

(57) ABSTRACT

Method, and apparatus, and computer readable medium embodying the computer program product are provided for instructing a pilot of an aircraft to go-around and make another approach and landing attempt. During an approach maneuver, it is determined whether an operational parameter of the aircraft exceeds a threshold and whether the aircraft has reached a decision height altitude. A go-around instruction to the pilot when the aircraft has reached the decision height altitude and the operational parameter exceeds the threshold.

### RELATED APPLICATION

This application claims the benefit of U.S. Provisional Application No. 61/773,642 filed Mar. 6, 2013.

### TECHNICAL FIELD

The technical field generally relates to aircraft, and more particularly relate to methods and apparatus for instructing a pilot of an aircraft to go-around and make another approach and landing attempt.

### BACKGROUND

Landing an aircraft is one of the most demanding maneuvers performed during flight. During the landing process, the aircraft must properly approach the runway, touchdown and slow to an appropriate ground speed within a given runway distance. While there have been significant advances in aircraft navigation and landing support systems, if the pilot of an aircraft attempts to land from a non-optimal height or speed, the runway distance may be insufficient to provide the desired landing distance for the aircraft.

In addition to aircraft speed and altitude, additional factors are commonly evaluated by the pilot during the approach and landing process. These factors may include aircraft operation (e.g., malfunctions), excessive wind conditions or contaminated runway conditions. If the pilot does not accurately estimate the energy of the aircraft and the remaining length of the runway, an overrun of the end of the runway is possible.

Pilots are trained to monitor these conditions during the approach, and to initiate a go-around maneuver if necessary. However, the decision to execute a go-around maneuver is left to the discretion of the pilot. Accordingly, the effectiveness of a pilot in safely landing the aircraft depends on the experience and judgment of the pilot. Accordingly, pilots with varying levels of experience and training may respond differently to the same situation, and some pilot responses may provide a less than optimal landing.

Accordingly, it is desirable to assist or augment a pilot during the approach and landing phase of flight. It is further desirable that the assistance or augmentation is as objective as possible and not dependent upon pilot skill or judgment. Other desirable features and characteristics will become apparent from the subsequent summary and detailed description and the appended claims, taken in conjunction with the accompanying drawings and the foregoing technical field and background.

### SUMMARY

In one embodiment, a method is provided in which a go-around instruction system for the aircraft is automatically or manually activated. During an approach maneuver, the system determines whether an operational parameter of the aircraft exceeds a threshold and whether the aircraft has reached a decision height altitude. The system provides a go-around instruction to the pilot when the aircraft has reached the decision height altitude and the operational parameter exceeds the threshold.

In another embodiment, an aircraft is provided that includes, but is not limited to a first apparatus that is configured to determine an aircraft speed and a second apparatus that is configured to determine an aircraft altitude. The aircraft also includes a flight system coupled to the first apparatus and the second apparatus that is configured to determine an aircraft energy from the aircraft speed and the aircraft altitude and whether the aircraft energy exceeds a threshold. When the aircraft has reached a decision height altitude, the system provides a go-around instruction if the aircraft energy exceeds the threshold.

### DESCRIPTION OF THE DRAWINGS

Embodiments of the present invention will hereinafter be described in conjunction with the following drawing figures, where like numerals denote like elements, and:

FIG. 1 is a block diagram of various aircraft flight systems in accordance with an embodiment;

FIG. 2 illustrates a landing approach of an aircraft in accordance an embodiment;

FIG. 3 is an illustration of an aircraft executing a go-around instruction in accordance with an embodiment; and

FIG. 4 is a flowchart of a method in accordance with an embodiment.

### DETAILED DESCRIPTION

As used herein, the word “exemplary” means “serving as an example, instance, or illustration.” The following detailed description is merely exemplary in nature and is not intended to limit application and uses. Any embodiment described herein as “exemplary” is not necessarily to be construed as preferred or advantageous over other embodiments. All of the embodiments described in this Detailed Description are exemplary embodiments provided to enable persons skilled in the art to make or use the embodiment and not to limit the scope that is defined by the claims. Furthermore, there is no intention to be bound by any expressed or implied theory presented in the preceding technical field, background, summary or the following detailed description.

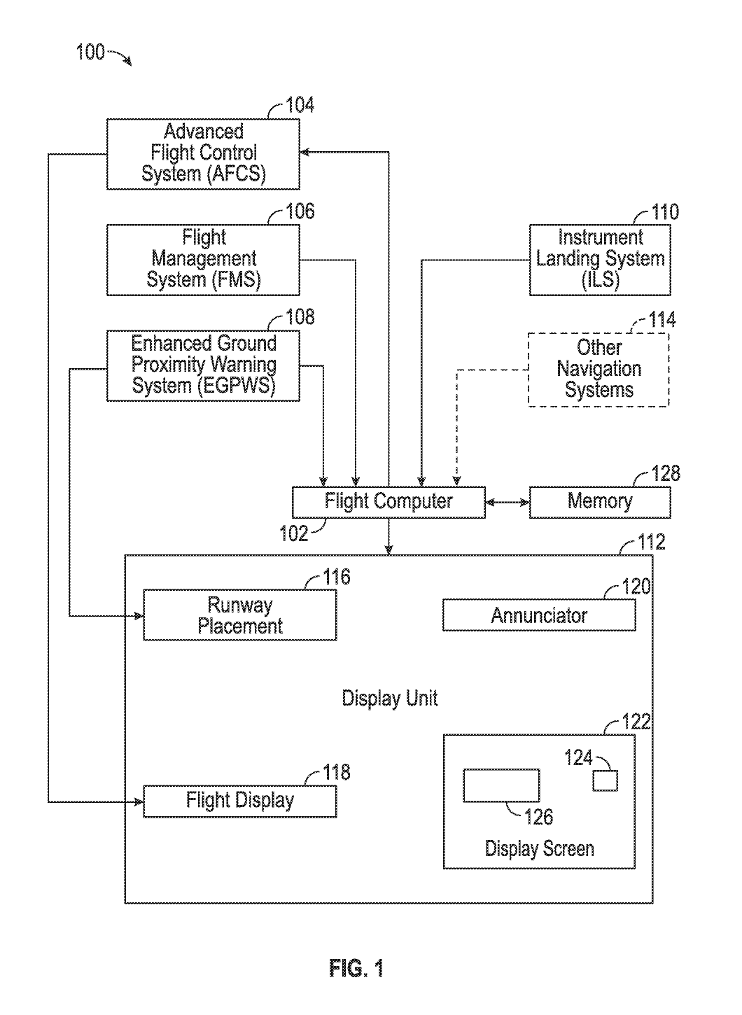

FIG. 1 is block diagram of various flight control systems 100 for an aircraft that implements a go-around maneuver system and/or is capable of executing a go-around maneuver method in accordance with exemplary embodiments. The various flight control systems 100 includes a flight computer 102, an Advanced Flight Control System (AFCS) 104, a Flight Management System (FMS) 106, an Enhanced Ground Proximity Warning System (EGPWS) 108, an Instrument Landing System (ILS) 110, and a display unit 112. Optionally, other proprietary or commercial navigation systems 114 provide additional navigational signals to the flight computer 102, such as, for example, Very High Frequency (VHF) omni-directional range (VOR) equipment; a non-directional beacon (NDB) system; a radio altimeter, a microwave landing system (MLS) or a Global Positioning System.

The FMS 106 is configured to provide to the flight computer 102 data regarding the flight including a landing approach plan, while the EGPWS 108 provides the flight computer 102 with a geometric altitude, where the geometric altitude represents a three-dimensional model of terrain. The flight computer 102 and the AFCS 104 collaborate in order to provide instructions to the pilot in order to direct the aircraft along a landing approach plan. The AFCS 104, the FMS 106, and the EGPWS 108 are disposable within the flight computer 110 or within other avionics shown in FIG. 1 or at other locations in an aircraft.

The Instrument Landing System (ILS) is used for high precision landing guidance and deviation from glideslope data. Typically, a transmitter located on the ground projects two sets of radio beams into space along the runway approach corridor. An aircraft equipped for an ILS landing includes, but is not limited to specialized antennas and receivers that interpret the radio beams and provide the pilot with navigational guidance. One of the radio beams provides lateral guidance, which allows the pilot to align the aircraft with the runway. The other radio beam provides vertical guidance to assist the pilot to maintain a steady decent along the glideslope to the runway.

The display unit 112 displays information regarding the status of the aircraft. The display unit 190 receives information from various systems to provide additional information to the pilot. For example, the EGPWS 108 generates information for a runway placement display 116 to the pilot regarding the position of the aircraft with respect to the runway. With this information and information provided by the ILS, the pilot is generally able to make the appropriate adjustments to ensure that the aircraft is in proper alignment with the runway. Also, the AFCS 104 is operable to provide to the display unit 112 information for a flight display 118, such as, for example, attitude of the aircraft, speed and other flight characteristics. The display unit 112 typically also includes, but is not limited to an annunciator 120 to provide verbal warnings, alert or warning tones or other audible information. Other display screens 122 of the display unit 112 include icons 124 that are illuminated to indicate the occurrence of certain conditions and a text message screen 126 to display text information.

In accordance with one embodiment, the various flight control systems 100 illustrated in FIG. 1 is implemented with software and/or hardware modules in a variety of configurations. For example, flight computer 102 comprises a one or more processors, software module or hardware modules. The processor(s) reside in single integrated circuits, such as a single or multi-core microprocessor, or any number of integrated circuit devices and/or circuit boards working in cooperation to accomplish the functions of the flight computer 102. The flight computer 102 is operable coupled to a memory system 128, which may contain the software instructions or data for the flight computer 102, or may be used by the flight computer 102 to store information for transmission, further processing or later retrieval. In accordance with one embodiment, the memory system 128 is a single type of memory component, or composed of many different types of memory components. The memory system 128 can include non-volatile memory (e.g., Read Only Memory (ROM), flash memory, etc.), volatile memory (e.g., Dynamic Random Access Memory (DRAM)), or some combination of the two. In an embodiment, the go-around instruction system is implemented in the flight computer 102 via a software program stored in the memory system 128.

Although not illustrated in FIG. 1, it will be appreciated that each of the various flight control systems 100 typically includes one or more sensors. In general, a sensor is a device that measures a physical quantity and converts the measurement into a signal received by a system or the flight computer 102. In general, sensors are used to sense any number of physical quantities, such as light, motion, temperature, magnetic fields, gravitational forces, humidity, vibration, pressure, electrical fields, current, voltage, sound, and other physical aspects of the aircraft or a surrounding environment. Non-limiting examples of sensors include, but is not limited to vibration sensors, air speed sensors, altimeter, gyroscope, inertial reference unit, magnetic compass, navigation instrument sensors, throttle position sensor, pitch, roll and yaw sensors, etc.

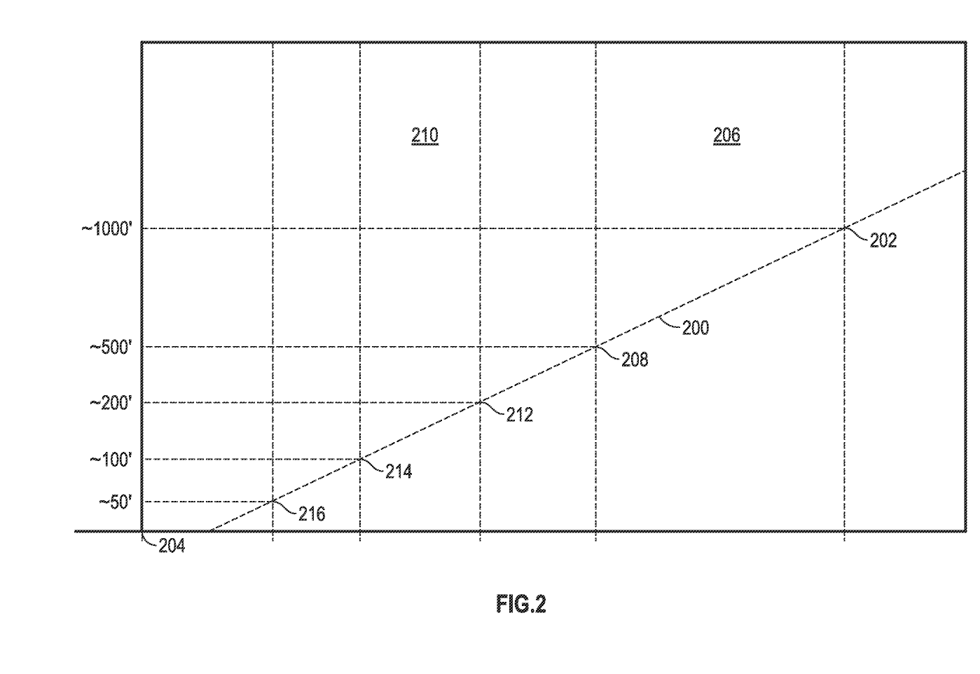

FIG. 2 illustrates a glideslope 200 for an aircraft, which is not shown in FIG. 2, during approach and landing utilizing the go-around instruction system in accordance an embodiment. As mentioned earlier, at some point, which is commonly referred to as a decision height, the pilot decides whether to land the aircraft or declare a missed approach and conducts a go-around maneuver. Typically, the decision height depends upon the landing system employed at the airport. That is, airport landing systems are categorized by the Federal Aviation Administration (FAA) or other certification authority into different categories (i.e., Category I, II, and III) depending upon levels of accuracy, integrity, continuity, and availability provided by the landing guidance system.

Accuracy refers to a volume in which an aircraft position fix is contained within ninety-five percent certainty (or higher depending upon the type of approach flown and the equipment utilized). Integrity refers to the probability that the system will not unintentionally provide hazardous misleading information, such as an undetected fault or lack of information. Integrity also refers to a time required for a detected fault to be flagged by the system. Continuity refers to the probability that the navigation accuracy and integrity requirements will remain supported during the approach.

Most airport landing systems fall in Category I (CAT I), which enables the aircraft to initiate approach procedures from a decision height of approximately 200 feet (approximately 60.96 meters). The decision height represents the lowest altitude, above the touchdown zone, that the aircraft can descend without the pilot making visual contact with the runway. In a CAT I landing, if the pilot has not made visual contact with the runway by the time the aircraft descends to approximately 200 feet (approximately 60.96 meters), then the pilot is expected to abort the landing attempt, go-around, and try again.

More restrictive than the CAT I landing is a Category II (CAT II) landing, where airport landing systems allow the aircraft to initiate final approach procedures from a decision height of at least approximately 100 feet (approximately 30.48 meters). An aircraft that is capable of a CAT II landing descends below the CAT I landing requirements before the pilot decides whether to land or go-around.

Airport landing systems categorized for CAT III allow for landing procedures from a decision height of at least approximately 50 feet (approximately 15.24 meters). However, aircraft configured for CAT III landings utilize special automatic landing or guidance systems, such as a triple redundant autopilot system, and meet specified levels of integrity and reliability.

With continued reference to FIG. 2, at point 202 of the glideslope 200, approximately 1000 feet (approximately 304.8 meters) above the runway 204, the AFCS 104 as shown in FIG. 1, and EGPWS 108 as shown in FIG. 1, begins to provide the pilot with the necessary guidance to align the aircraft with the landing approach plan and correct any deviation of the aircraft along the glideslope 200. At a point in approach segment 206 (e.g., in a range of approximately 1000 feet (approximately 304.8 meters) and approximately 500 feet (approximately 152.4 meters), the go-around instruction system activates. In some embodiments, the go-around instruction system is manually activated by the pilot or co-pilot. Preferably, in manual activation embodiments, activation by the pilot or co-pilot is part of an approach and landing Standard Operation Procedure (SOP) provided by the airline company employing the flight crew. In some embodiments, activation of the go-around instruction system is automatic, such as by the flight computer 102 as shown in FIG. 1, at some point in approach segment 206.

Once activated at a point 208 of the glideslope, which is approximately 500 feet (approximately 152.4 meters) above the runway 204, the go-around instruction system is monitoring one or more operational parameters of the aircraft to determine whether to instruct the pilot to go-around and attempt another approach and landing. According to exemplary embodiments, this instruction is not guidance or advice, but rather, a mandatory instruction carrying the same force and affect as if local Air Traffic Control (ATC) had instructed the pilot to go-around. Preferably, the responsible aviation authority (i.e., the Federal Aviation Administration (FAA) in the United States of America), would mandate that the pilot obey the instruction unless an emergency condition exists (e.g., not enough fuel to go-around, aircraft malfunction, a passenger medical emergency, or other condition specified by the responsible aviation authority).

In some embodiments, as the aircraft continues to descend along the glideslope 200 in approach segment 210, the go-around instruction system continues to monitor the one or more operational parameters of the aircraft. Non-limiting examples of aircraft operational parameters include aircraft energy (i.e., kinetic energy and potential energy), aircraft speed, aircraft position high or low of the glideslope or rate of decent. In some embodiments, the go-around instruction system may monitor the one or more operational parameter once prior to making the go-around determination. Depending upon the landing system in use (i.e., CAT I, CAT II or CAT III, which is known via the FMS 106 in FIG. 1), the go-around instruction system initiates a go-around determination at the appropriate decision height 212, such as approximately 200 feet (approximately 60.96 meters), 214, approximately 100 feet (approximately 30.48 meters) or 216 approximately 50 feet (approximately 15.24 meters), for example. If the determination is that a safe landing is possible, the go-around instruction system is deactivated after the aircraft falls below a minimum decision height.

In some embodiments, the minimum decision height is approximately 25 feet (approximately 7.62 meters) below the appropriate decision height. In some embodiments, the go-around instruction system is deactivated below the lowest decision point 216. Deactivation may be manual via the flight crew or automatic via the flight computer 102 in FIG. 1 or other aircraft system).

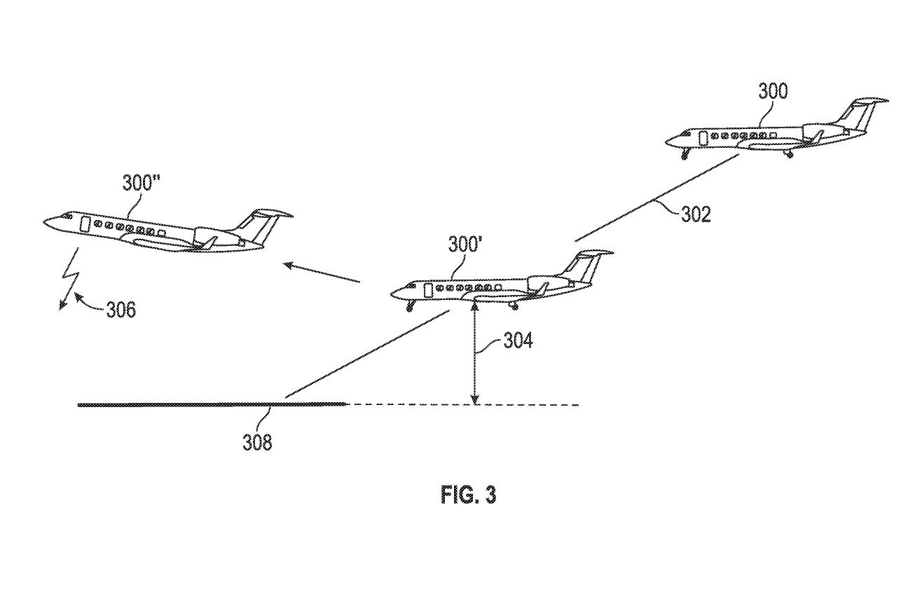

FIG. 3 is an illustration of a situation where the go-around instruction system provides a go-around instruction to the pilot. According to an exemplary embodiment, the pilot is expected to follow the instruction and go-around for another approach and landing attempt. If the pilot does not follow the go-around instruction, the go-around instruction system logs the non-compliance and/or transmits a non-compliance signal to the local Air Traffic Control.

For example, consider aircraft 300 descending along glideslope 302. In this example, the aircraft 300 is at an altitude where the go-around instruction system is active and monitoring one or more operational parameters (e.g., aircraft energy). At the appropriate decision height 304, the go-around instruction system provides a go-around instruction to the pilot of the aircraft 300. This might occur, for example, if the go-around instruction system determined that the energy of the aircraft 300′ is too high and above the glideslope of the aircraft 300, which is typically referred to as the aircraft being high and hot”).

In some embodiments the go-around instruction is provided as a verbal instruction or audible tone or alarm via the annunciator 120 as shown in FIG. 1. In some embodiments, a go-around icon is illuminated, such as icon 124 in FIG. 1). In some embodiments a go-around instruction is provided as a text instruction via a text message screen 126 as shown in FIG. 1. In some embodiments, a combination of audible, text and illuminated icons are used to provide the pilot with multiple auditory and visual instructions to go-around.

As mentioned earlier, the pilot is expected to follow the instruction and go-around for another approach and landing attempt. In some embodiments, the pilot is provided with go-around indicators on the display unit 112 as shown in FIG. 1 that indicate a direction that the aircraft takes in the go-around maneuver. In some embodiments, the pilot is instructed to take the flight path indicated by the go-around indicators. Assuming the pilot follows the go-around instruction; the pilot of the aircraft 300 announces a missed approach, indicated by transmission 306, increases power and climbs as illustrated in FIG. 3.

According to exemplary embodiments, the go-around instruction system has one or more parameters to determine pilot compliance or non-compliance with the go-around instruction. Table 1 provides some non-limiting examples of some of the parameters the go-around instruction system employs to determine compliance with the go-around instruction.

TABLE 1
Increasing power (or applying full power)
Adopting an appropriate climb attitude and airspeed
Removing at least one stage of flap
A positive rate of climb (approximately 3° per second)
Raising the landing gear (if retractable)

Conversely, declining altitude following the instruction or landing the aircraft on the runway 308 are indicators of non-compliance. If the pilot does not follow the go-around instruction, the go-around instruction system logs/stores the non-compliance information in memory system 128 as shown in FIG. 1, for example, and/or transmits a non-compliance signal to the local ATC.

Ideally, a pilot that does not follow a go-around instruction would self-report the event and provide a justification for ignoring the go-around instructions (e.g., an emergency). Failure a pilot to self-report is detectable with a subsequent review of the stored/logged non-compliance data. In such a case, a disciplinary action could be taken against the recalcitrant pilot or additional training may be required by the administrative agency.

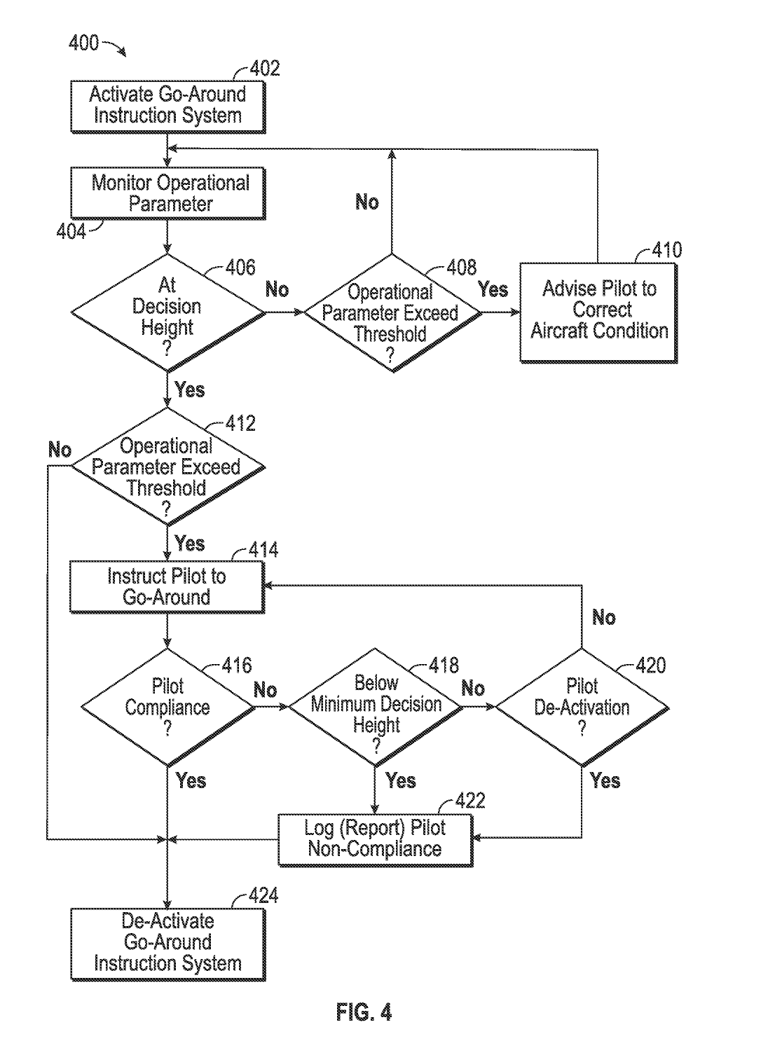

FIG. 4 is a flowchart of a method 400 performed by the go-around instruction system in accordance with an embodiment. In one embodiment, the various tasks performed in connection with the method 400 of FIG. 4 are performed by software executed in a processing unit, hardware, firmware, or any combination thereof. For illustrative purposes, the following description of the method 400 of FIG. 4 refers to elements mentioned above in connection with FIG. 1 to FIG. 3.

In an embodiment, portions of the method of FIG. 4 performed by different elements of the described system. However, in accordance with another embodiment, portions of the method of FIG. 4 are performed by a single element of the described system.

It should also be appreciated that the method of FIG. 4 include no additional or alternative tasks or includes any number of additional or alternative tasks and that the method of FIG. 4 is incorporated into a more comprehensive procedure or process having additional functionality not described in detail herein or implemented as a stand-alone procedure. Moreover, one or more of the tasks shown in FIG. 4 are removable from an embodiment of the method 400 of FIG. 4 as long as the intended overall functionality remains intact.

The routine begins in step 402 with an activation of the go-around instruction system. In some embodiments, the go-around instruction system is activated at an altitude between approximately 1000 feet (approximately 304.8 meters) and approximately 500 feet (approximately 152.4 meters). In some embodiments, the go-around instruction system is activated just prior to a decision height. For example, the decision height is approximately 200 feet (approximately 60.96 meters), approximately 100 feet (approximately 30.48 meters), or approximately 50 feet (approximately 15.24 meters). The go-around instruction system is manually activated by the flight crew or automatically activated such as by the flight computer 102 as shown in FIG. 1).

After activation of the go-around instruction system, step 404 monitors one or more operational parameters (e.g., energy) of the aircraft. Decision 406 determines whether the aircraft has reached the appropriate decision height. If not, then in some embodiments, decision 408 determines whether the operational parameter exceeds the threshold, and if so, step 410 advises the pilot to correct the aircraft condition causing the operational parameter to exceed the threshold.

As a non-limiting example, the pilot is advised to reduce power if the energy of the aircraft exceeds a threshold. As noted above, in some embodiments, aircraft operational parameter monitoring is done on a periodic or continuous basis. Accordingly, a negative determination of decision 408, or after providing the advisory of step 410, the routine returns to step 404 for further monitoring of the operational parameter(s). In some embodiments, the monitoring of the operational parameter(s) is performed just prior to the decision height. Accordingly, an affirmative determination of decision 408 causes decision 412 to determine if the operational parameter (e.g., energy) exceeds the threshold. If so, the pilot is instructed to go-around in step 414.

As mentioned earlier, the pilot is expected to follow the instruction and go-around for another approach and landing attempt. Thus, decision 416 determines whether the pilot has complied with the go-around instruction. Factors of determining whether the pilot has complied with the go-around instruction were discussed above in connection with FIG. 3 and will not be repeated for the sake of brevity. If the pilot has not complied with the go around instruction, decision 418 determines whether the aircraft has reached a minimum decision height. The minimum decision height, for example, is approximately 25 feet (approximately 7.62 meters) below the decision height.

If the determination of decision 418 is that the aircraft has not reached the minimum decision height, decision 420 determines whether the pilot has manually deactivated the go-around instruction system. Such a deactivation by the pilot would have occurred if the pilot had declared an emergency situation (e.g., low fuel, aircraft malfunction or a passenger medical emergency). However, if the pilot has not manually deactivated the go-around instruction system, the routine returns to step 414 and the instruction to go-around is repeats. Conversely, if the pilot has deactivated the go-around instruction system or if decision 418 determines that the minimum decision height is reached, step 422 logs/stores pilot non-compliance information, for example in the memory system 128 as shown in FIG. 1).

Generally, the pilot is expected to follow the go-around instruction and the determination of decision 416 will be that the pilot has complied with the instruction. In this case, or if the determination of decision 412 is that the threshold was not exceeded, or after logging pilot non-compliance (step 422), the go-around instruction system is deactivated in step 424. In an embodiment, the deactivation is a manual deactivation by the flight crew or in another embodiment the deactivation is automatically performed by the flight computer 102 in FIG. 1) when the aircraft has reach an altitude below the minimum decision height or the lowest decision height recognized by the flight computer.

The disclosed methods and systems provide a go-around instruction system for an aircraft that enhances safe air travel by augmenting pilot judgment with an objective determination of whether an aircraft is appropriately approaching and landing on a runway. A requirement to comply with the go-around instruction reduces pilot error or misjudgment resulting in a safer approach and landing for the aircraft.

It will be appreciated that the various illustrative logical blocks/tasks/steps, modules, circuits, and method steps described in connection with the embodiments disclosed herein may be implemented as electronic hardware, computer software, or combinations of both. Some of the embodiments and implementations are described above in terms of functional and/or logical block components or modules and various processing steps. However, it should be appreciated that such block components or modules may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope as set forth in the claims.

For example, an embodiment of a system or a component may employ various integrated circuit components, for example, memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The word exemplary is used exclusively herein to mean serving as an example, instance, or illustration. Any embodiment described herein as “exemplary” is not necessarily to be construed as preferred or advantageous over other embodiments.

The steps of a method described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC.

In this document, relational terms such as first and second, and the like may be used solely to distinguish one entity or action from another entity or action without necessarily requiring or implying any actual such relationship or order between such entities or actions. Numerical ordinals such as first, second, third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as connect or coupled to that are used in describing a relationship between different elements does not imply that a direct physical connection must be made between these elements. For example, two elements may be connected to each other physically, electronically, logically, or in any other manner, through one or more additional elements.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof

What is claimed is:

1. A landing method for an aircraft, comprising:
activating a go-around instruction system for the aircraft;
determining whether an operational parameter of the aircraft exceeds a threshold;
determining whether the aircraft has reached a decision height altitude; and
providing a go-around instruction when the aircraft has reached the decision height altitude and the operational parameter exceeds the threshold.

2. The landing method for the aircraft according to claim 1, further comprising determining whether an operator of the aircraft has complied with the go-around instruction.

3. The landing method for the aircraft according to claim 2, further comprising repeating the go-around instruction when the operator of the aircraft has not complied with the go-around instruction.

4. The landing method for the aircraft according to claim 3, further comprising ceasing the repeating the go-around instruction when the operator of the aircraft has not complied with the go-around instruction and the aircraft has reached an altitude below a minimum decision height.

5. The landing method for the aircraft according to claim 2, further comprising logging pilot non-compliance information when the operator does not complied with the go-around instruction.

6. The landing method for the aircraft according to claim 5, further comprising transmitting a pilot non-compliance signal when the operator does not complied with the go-around instruction.

7. The landing method for the aircraft according to claim 2, further comprising logging pilot non-compliance information if the operator deactivates the go-around instruction system prior to landing the aircraft.

8. The landing method for an aircraft according to claim 1, further comprising reducing a power advisory when an aircraft energy operational parameter exceeds the threshold but the aircraft has not reached the decision height altitude.

9. The landing method for an aircraft according to claim 1, wherein providing the go-around instruction when the aircraft has reached the decision height altitude and the operational parameter exceeds the threshold comprises providing an audible instruction.

10. A landing method for an aircraft, comprising:
receiving an aircraft speed by a flight computer;
receiving an aircraft altitude by the flight computer;
determining an aircraft energy from the aircraft speed and the aircraft altitude;
determining whether the aircraft energy exceeds a threshold;
determining whether the aircraft has reached a decision height altitude; and
issuing a go-around instruction from the flight computer when the aircraft has reached the decision height altitude and the aircraft energy exceeds the threshold.

11. The landing method for the aircraft according to claim 10, further comprising determining whether a pilot of the aircraft has complied with the go-around instruction.

12. The landing method for the aircraft according to claim 11, further comprising deactivating the go-around instruction when the pilot of the aircraft has complied with the go-around instruction and the aircraft has reached an altitude below a minimum decision height.

13. The landing method for the aircraft according to claim 11, further comprising repeating the go-around instruction when the pilot of the aircraft has not complied with the go-around instruction and the aircraft has an altitude above a minimum decision height.

14. The landing method for the aircraft according to claim 13, further comprising ceasing to repeat the go-around instruction when the pilot of the aircraft has not complied with the go-around instruction and the aircraft has reached a second altitude that is below the minimum decision height.

15. The landing method for the aircraft according to claim 11, further comprising logging a pilot non-compliance information when the pilot does not complied with the go-around instruction and the aircraft has reached an altitude below a minimum decision height.

16. An aircraft, comprising:
a first apparatus that is configured to determine an aircraft speed;
a second apparatus that is configured to determine an aircraft altitude;
a flight system coupled to the first apparatus and the second apparatus that is configured to, the flight system configured to:
determine an aircraft energy from the aircraft speed and the aircraft altitude;
determine whether the aircraft energy exceeds a threshold;
determine whether the aircraft has reached a decision height altitude; and
provide a go-around instruction when the aircraft has reached the decision height altitude and the aircraft energy exceeds the threshold.

17. The aircraft according to claim 16, wherein the flight system is further configured to determine whether a pilot of the aircraft has complied with the go-around instruction.

18. The aircraft according to claim 17, wherein the flight system is further configured to deactivate the go-around instruction when the pilot of the aircraft has complied with the go-around instruction and the aircraft has reached an altitude below a minimum decision height.

19. The aircraft according to claim 17, wherein the flight system is further configured to repeat the go-around instruction when the pilot of the aircraft has not complied with the go-around instruction and the aircraft has an altitude above a minimum decision height.

20. The aircraft according to claim 11, further comprising logging pilot non-compliance information when the pilot has not complied with the go-around instruction and the aircraft has reached an altitude below a minimum decision height.

21. A non-transitory computer readable medium embodying a computer program product, said computer program product comprising:
an aircraft landing program, the aircraft landing program configured to:
activate a go-around instruction system for an aircraft;
determine whether an operational parameter of the aircraft exceeds a threshold;
determine whether the aircraft has reached a decision height altitude; and
provide a go-around instruction when the aircraft has reached the decision height altitude and the operational parameter exceeds the threshold.

22. The non-transitory computer readable medium embodying the computer program product according to claim 21, the aircraft landing program further configured to determine whether an operator of the aircraft has complied with the go-around instruction.

23. The non-transitory computer readable medium embodying the computer program product according to claim 22, the aircraft landing program further configured to repeat the go-around instruction when the operator of the aircraft has not complied with the go-around instruction.

24. The non-transitory computer readable medium embodying the computer program product according to claim 23, the aircraft landing program further configured to cease the repeat to the go-around instruction when the operator of the aircraft has not complied with the go-around instruction and the aircraft has reached an altitude below a minimum decision height.

25. The non-transitory computer readable medium embodying the computer program product according to claim 22, the aircraft landing program further configured to log a pilot non-compliance information when the operator does not complied with the go-around instruction.

26. The non-transitory computer readable medium embodying the computer program product according to claim 25, the aircraft landing program further configured to transmit a pilot non-compliance signal when the operator does not complied with the go-around instruction.

27. The non-transitory computer readable medium embodying the computer program product according to claim 22, the aircraft landing program further configured to log pilot non-compliance information if the operator deactivates the go-around instruction system prior to landing the aircraft.

28. The non-transitory computer readable medium embodying the computer program product according to claim 21, the aircraft landing program further configured to reduce a power advisory when an aircraft energy operational parameter exceeds the threshold but the aircraft has not reached the decision height altitude.

29. The non-transitory computer readable medium embodying the computer program product according to claim 21, wherein the aircraft landing program is further configured to provide an audible instruction for the go-around instruction when the aircraft has reached the decision height altitude and the operational parameter exceeds the threshold comprises.
